(19) United States
(12) Patent Application Publication
(10) Pub. No.: US 2016/0069105 A1
(43) Pub. Date: Mar. 10, 2016

(54) UNIVERSAL STRIKE PLATE SADDLE

(71) Applicant: David B. MAGEE, Chapel Hill, NC (US)

(72) Inventor: David B. MAGEE, Chapel Hill, NC (US)

(21) Appl. No.: 14/786,263

(22) PCT Filed: Apr. 30, 2015
(86) PCT No.: PCT/US15/28561

§ 371 Date: Oct. 22, 2015

Related U.S. Application Data
(60) Provisional application No. 61/986,415, filed on Apr. 30, 2014.
(60) Provisional application No. 62/079,838, filed on Nov. 14, 2014.

(51) Int. Cl. E05B 15/02; E05C 21/00; E05C 19/00

(52) U.S. Cl. CPC E05B 15/025; E05C 19/00; E05C 21/00

(57) ABSTRACT

A universal strike plate system for use on a strike jamb is provided. The strike plate system may include a face plate. The face plate may include a back surface configured for mounting the strike plate saddle onto the strike jamb; a strike plate seat for mounting a strike plate to the strike plate seat, wherein strike plate seat is recessed relative to a front face of the face plate as a recessed area of a front face surface; and an elongated vertical side forming an open side of the strike plate seat configured to receive a latch or bolt mounted on a door. The strike plate seat defines a primary through hole to receive the latch or the bolt, and the strike plate seat further defines at least two secondary through holes configured to receive fastening members so as to mount said strike plate saddle onto said strike jamb.

### CROSS-REFERENCE TO RELATED APPLICATIONS

The present application claims the benefit of U.S. Provisional Application No. 61/986,415, filed on Apr. 30, 2014, and U.S. Provisional Application No. 62/079,838, filed on Nov. 14, 2014, both of which are incorporated by reference herein in their entireties.

### BACKGROUND

Latch-strike misalignment is a common problem with wooden doors and doorframes. Often, the cause is gravitational pull on the unsupported swinging edge of the door. It torques the door and hinge jamb with two implications.

First, the clearance between the latch face and strike plate widens thereby causing excess play or “chatter” in the latch.

Second, as the door tilts, so does the latch plane. Eventually, the tilting latch crosses the stationary strike plate on a plane too low to properly catch the strike plate hole. When this occurs, the latch becomes non-functional.

### SUMMARY

Embodiments of the present application pertain to the field of locks and, more specifically, to attachments, accessories or adjuncts for locking mechanisms.

In one embodiment of the present disclosure, an apparatus mounts directly onto the strike jamb, straddles and covers the exposed strike plate mortise in the strike jamb, and acts as a base mount for the repositioned strike plate.

In another embodiment, a universal strike plate system for use on a strike jamb is provided. The universal strike plate system may include a face plate. The face plate may include a back surface configured for mounting the strike plate saddle onto the strike jamb; a strike plate seat for mounting a strike plate to the strike plate seat, wherein strike plate seat is recessed relative to a front face of the face plate as a recessed area of a front face surface; and an elongated vertical side forming an open side of the strike plate seat configured to receive a latch or bolt mounted on a door. The strike plate seat defines a primary through hole to receive the latch or the bolt, and the strike plate seat further defines at least two secondary through holes configured to receive fastening members so as to mount said strike plate saddle onto said strike jamb.

According to another embodiment, a method of mounting a strike plate onto a strike jamb may include providing a strike plate saddle to be mounted to the strike jamb, where the strike plate saddle may include a face plate that defines a recessed area for receiving a strike plate, and the recessed area defines a primary through hole that is configured to receive a door latch or door bolt and secondary through holes. The strike plate saddle is aligned on the strike jamb so that the latch or the lock bolt of a door aligns with a vertical center of the primary through hole in the strike plate saddle. The strike plate saddle is affixed onto the strike jamb with one or more fasteners through secondary through holes in the strike plate saddle. The strike plate is aligned on the face of the strike plate saddle. The strike plate is pressed against the recessed area of the strike plate saddle and is secured to the strike plate saddle and the strike jamb with fasteners inserted through mounting holes in the strike plate that then pass through secondary holes in the strike plate saddle and into the strike jamb.

Embodiments of the present application improve the result and simplify the repair of a chattery latch or misaligned strike plate;

### BRIEF DESCRIPTION OF THE DRAWINGS

Aspects of the present invention are further described in the detailed description which follows in reference to the noted plurality of drawings by way of non-limiting examples of embodiments of the present invention in which like reference numerals represent similar parts throughout the several views of the drawings and wherein:

FIG. 1 is a vertical perspective view showing the face and the open side of a universal strike plate apparatus according to one embodiment;

FIG. 2 is a vertical perspective view showing the back and closed side of the universal strike plate apparatus according to one embodiment;

FIG. 3 is a horizontal perspective view showing the face, open side, and top or bottom of the universal strike plate apparatus according to one embodiment;

FIG. 4 is a semi-diagrammatic view from the same perspective as FIG. 1 but showing how the invention and strike plate mount to the strike jamb according to one embodiment;

FIG. 5 is a vertical sectional view showing a properly aligned latch bolt and strike plate;

FIG. 6 is a vertical sectional view showing a misaligned latch bolt and strike plate; and

FIG. 7 is a vertical sectional view showing an otherwise misaligned latch bolt and strike plate after being repaired using the invention.

### DETAILED DESCRIPTION

Embodiments of the present application solve two problems commonly encountered with wooden doors and doorframes. Both can occur when gravitational pull on the swinging edge of the door causes the hinge jamb and door to torque.

The first problem is latch chatter caused by excess clearance between the latch face and strike plate. A method used to repair this problem and reduce this excess gap is to place shims between the door hinges and hinge jamb. This method requires more skill and knowledge, however, than most homeowners possess. Compared to this and other methods, repairing this problem using embodiments of the invention require less skill and time to perform.

The second problem is latch-strike misalignment. It often follows and is accompanied by the previously described excess gap problem. A common method of repairing latch-strike misalignment is to remove and reposition the strike plate on the strike jamb in a multi-step process as follows:
(a) Remove the strike plate;
(b) Realign the strike plate, vertically and horizontally, on the strike jamb so that the latch properly crosses the strike plate and intersects with the latch hole in the strike plate;
(c) While holding the strike plate in the realigned position, trace the perimeter of the strike plate onto the strike jamb;
(d) Using a chisel, carve the mortise for the strike plate to a depth equal to the thickness of the strike plate;
(e) Holding the strike plate in the newly carved mortise, trace the interior perimeter of the latch hole;
(f) Remove the strike plate from the carved mortise then drill and shape the latch hole mortise as necessary in the strike jamb;
(g) If the new position for either strike plate mounting screw is over or too close to the latch hole mortise, fill the latch hole mortise or some part thereof with wood filler and allow it to dry;
(h) Hold the strike plate in the carved mortise and affix the strike plate to the strike jamb with the mounting screws; then
(i) Putty, sand and paint any exposed mortise.

Embodiments of the present disclosure solve both described problems with fewer steps and tools, in less time, and require less skill and knowledge than other methods of repair.

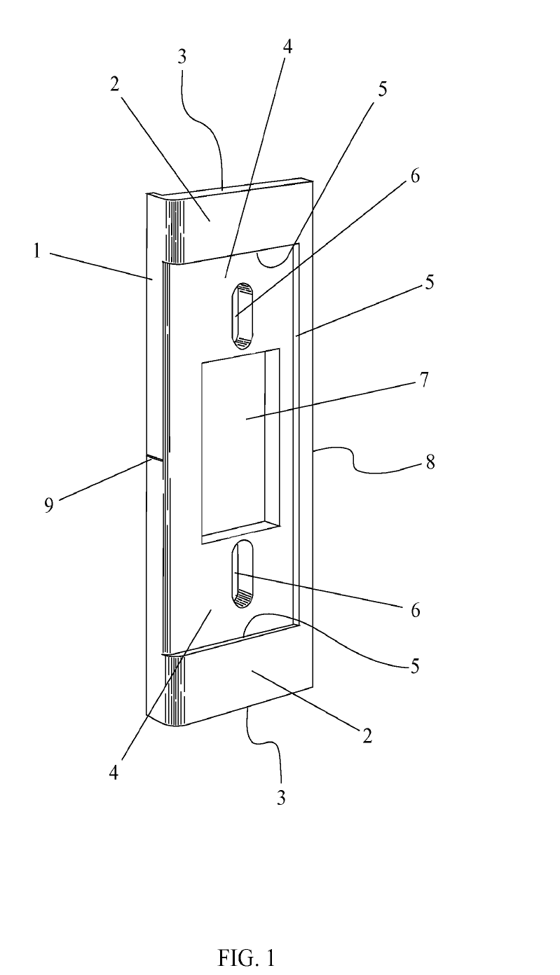

As shown in FIG. 1, one embodiment provides that the universal strike plate system is 90 millimeters in height and 36 millimeters in width and may be 6 millimeters thick except as otherwise noted along the vertical open side (1) edge where it is 7.5 millimeters thick, and in the area of the strike plate seat (4) where it may be 4.5 millimeters thick.

As further shown in the exemplary embodiment of FIG. 1, the face plate (also referred to herein as the “face”) (2) of the apparatus defines a recessed rectangular-shaped area called the strike plate seat (4) that serves the same purpose as a strike plate mortise. It should be understood that the shape of the strike plate seat (4) may take other shapes and should not be limited to be rectangular.

Like a strike plate mortise, the strike plate seat (4) may be recessed from the face (2) surface so as to permit most strike plates to sit flush or nearly flush with the face (2) when mounted. The strike plate seat (4) may be any dimensions, such as 70 millimeters high, 32 millimeters wide, and may be centered vertically within the face (2), as shown in the exemplary figures.

The strike plate seat (4) may be horizontally (relative to the floor to be substantially parallel to the floor for example) open to and flush with an open side (1) of the apparatus. In one embodiment, the open side (1) may mean the side which the latch (24) enters the face (2). The vertical edge of the open side (1) of the strike plate seat (4) may be rounded so as to better accept curved lips of standard strike plates currently in use.

As further shown in FIG. 1, the strike plate seat (4) may have a rectangular shaped hole called the strike plate hole (7) that may be of any dimension, such as 30 millimeters high, 18 millimeters wide and extends all the way through the strike plate seat. The strike plate hole (7) may be centered vertically (e.g., along a longitudinal length of the face plate) and/or horizontally in the strike plate seat (4). The strike plate hole (7) may be positioned horizontally 9 millimeters from the edge of the open side (1). When mounted, the strike plate hole (7) accepts or receives the latch and serves a similar purpose as a mortised latch hole in a strike jamb.

As further shown in FIG. 1, the apparatus may define two mounting canals or apertures (6), which may be horizontal and/or vertical. The purpose of these mounting canals (6) may be to permit mounting screws to pass from various standard strike plates through the universal strike plate system and into the strike jamb. Each mounting canal may be 12 millimeters high, 5.5 millimeters wide, and penetrates completely through the apparatus. The mounting canals (6) may be positioned in the strike plate seat (4) on either side of the strike plate hole (7) with one positioned, for example, 2 millimeters above the strike plate hole (7) and extending upward along the longitudinal length of the strike seat plate and the other positioned, for example, 2 millimeters below the strike plate hole (7) and extending downward along the longitudinal length of the strike seat plate, as shown in FIG. 1. Both mounting canals (6) may be horizontally positioned, for example, 15 millimeters from the open side (1).

As further shown in FIG. 1, a formed horizontal line called the centerline (9) may bisect the open side (1). This centerline (9) may be used as a visual alignment aid when mounting the universal strike plate system on the strike jamb. The objective when mounting the universal strike plate system is to align the centerline (9) with the point on the strike jamb where the vertical center of the latch or bolt makes contact with the strike jamb when closing, according to one embodiment.

As further shown in FIG. 1, the universal strike plate system may be formed using any material, such as hard plastic. However, it could be effectively produced using a variety of materials including polyhydroxybutyrate, bioplastics, polylactides, wood, metal and/or glass.

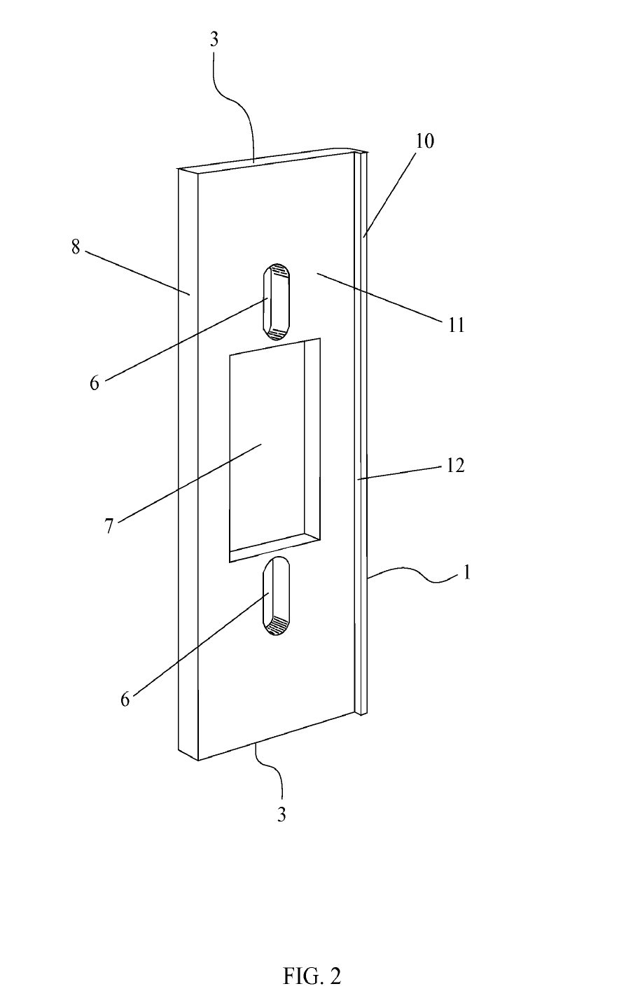

As shown in FIG. 2, the back (11) of the universal strike plate system may have a back surface that may be flat except along the edge of the open side (1) where a vertical ridge, referred to herein as the mortise skirt (10), may extend the full height of the apparatus from top to the bottom. The outside of the mortise skirt (10) may be flush with and constitutes part of the open side (1). The inside of the mortise skirt (10) may be formed by the mortise skirt wall (12) which may be perpendicular to the back (11) and parallel to the open side (1). The mortise skirt wall (12) may be any dimension, such as 3 millimeters wide, 90 millimeters high, and 2 millimeters thick. The purpose of the mortise skirt (10) may be two-fold: first, it could hide the exposed edge of the strike plate mortise; and, second, it could serve as an alignment aid when mounting the universal strike plate system onto the strike jamb. The objective when mounting the universal strike plate system may be to place the back (11) flat against the strike jamb so that the mortise skirt wall (12) may be flush against the outside edge of the strike jamb.

As further shown in FIG. 2, the strike plate hole (7) and both vertical mounting canals (6) extend through the back (11).

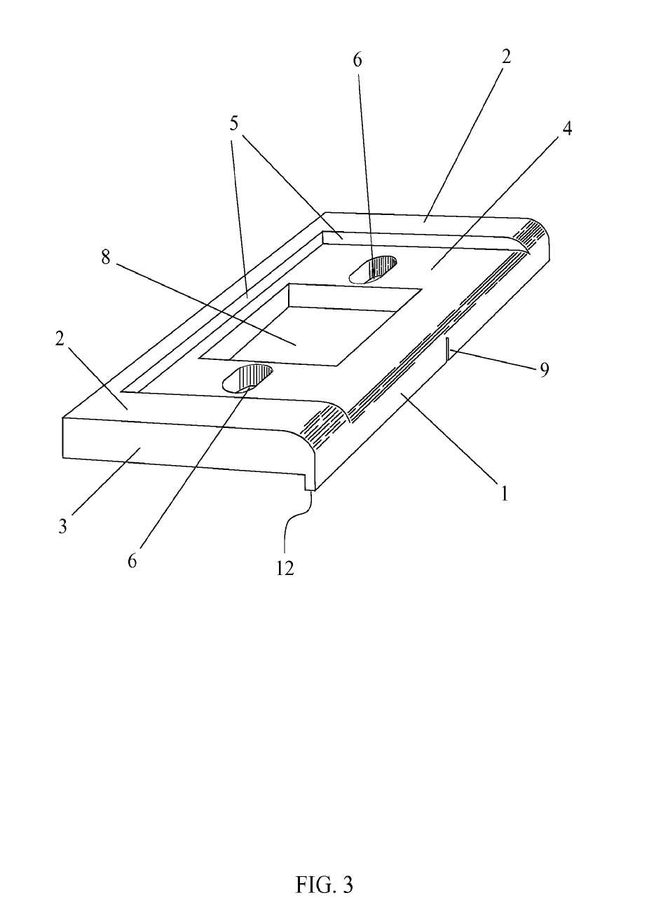

As shown in FIG. 3, the strike plate seat (4) is open to the open side (1) of the strike plate (meaning that the strike plate seat (4) extends completely to the edge of the open side (1) of the universal strike plate system in one aspect), but closed (meaning that the strike plate seat does not extend completely to) on the top, bottom and side opposite the open side of the universal strike plate system. These three closed sides of the strike plate seat (4), called strike plate seat walls (5), may be perpendicular to the strike plate seat (4) and face (2). The corner where the open side (1) and strike plate seat (4) join may be curved so as better accommodate the curved lip on standard strike plates.

As is also shown in FIG. 3, the mortise skirt (10) forms a ridge protruding toward the back along the open side (1) as more fully described in FIG. 2.

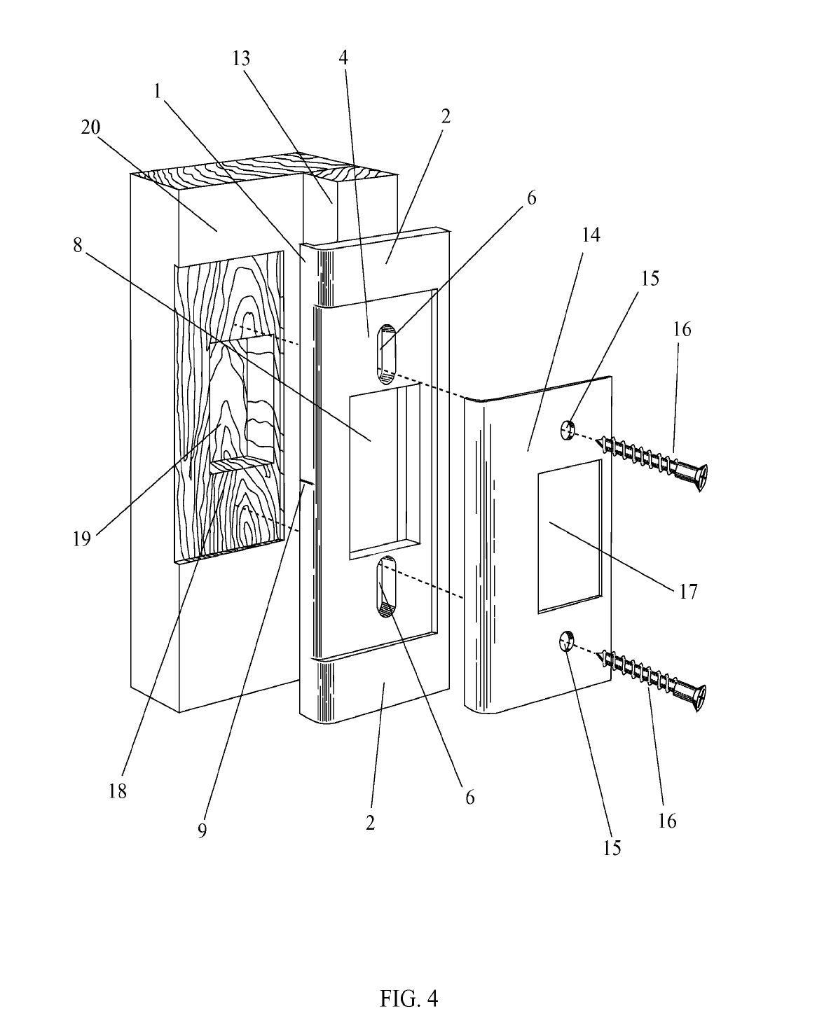

As shown in FIG. 4, the first step in effectuating a repair using the universal strike plate system may be to remove an already-installed standard strike plate (14) from the strike jamb (20) thereby exposing the strike plate mortise (18) and latch hole mortise (19) in the strike jamb (20). Of course, if there is no strike plate installed, this step is skipped.

The next step is to align the universal strike plate system for mounting on the strike jamb (20). This is accomplished by placing the back (11) against the strike jamb (20) with the mortise skirt wall (12) flush against the outside corner of the strike jamb (20).

The universal strike plate system may be then vertically positioned to where the centerline (9) is even with that point on the strike jamb (20) where the vertical center of the latch or bolt contacts the strike jamb (20) when closing. With the universal strike plate system properly positioned, the strike plate (14) is placed against the strike plate seat (4). The strike plate (14) may be positioned with the curved lip or tongue of the strike plate (14) aligned toward the open side (1) of the strike plate seat (4) then centered vertically in the strike plate seat (4).

Once the apparatus and strike plate (14) are properly positioned, the apparatus is secured to the strike jamb (20) with a fastening means, which can be done by inserting two mounting screws (16) through the strike plate mounting holes (15). Mounting screws (16) pass through the apparatus by way of the vertical mounting canals (6) and into the strike jamb (20). It should be understood that the universal strike plate system could be fastened using other fastening means, such as adhesive, nails, etc.

FIG. 5 shows a properly aligned latch (24) and strike plate (14) requiring no repair, according to one embodiment. The latch (24) extends horizontally into the latch hole mortise (19) with minimal clearance between the door (25) and the strike jamb (20).

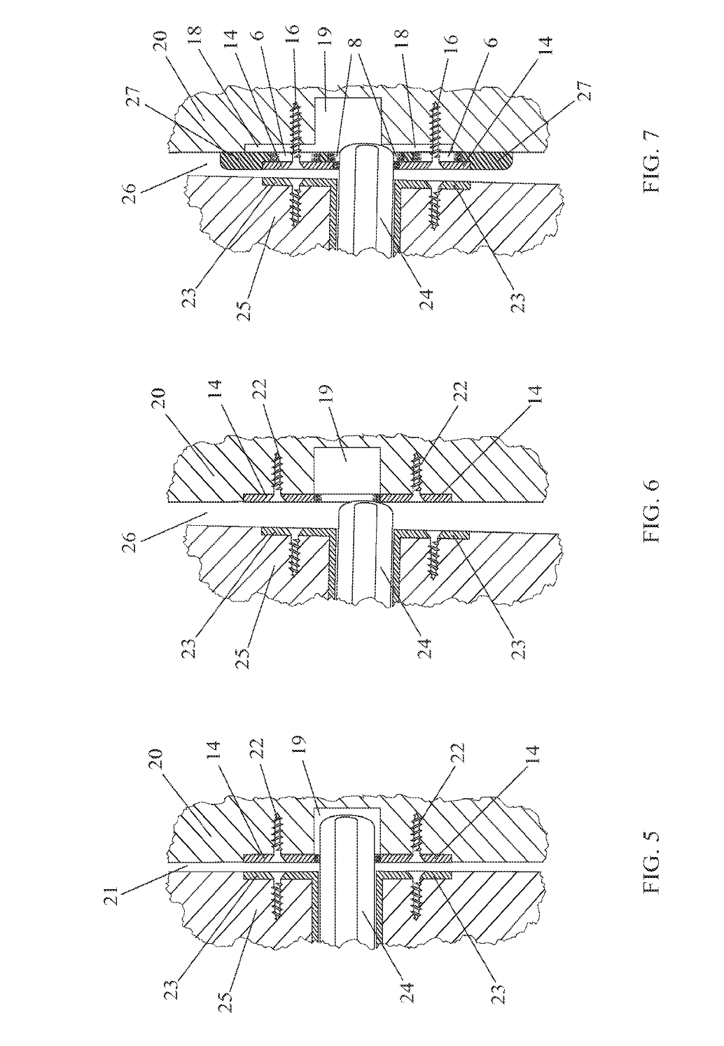

FIG. 6 shows a misaligned latch (24) and strike plate (14) with excess space (26) between the latch face (23) and strike plate (14), according to one embodiment. The latch (24) has missed the latch hole (17) and failed to properly seat in the latch hole mortise (19).

FIG. 7 shows a misaligned latch (24) and strike plate (14) with excess space (26) between the latch face (23) and strike plate (14) that has been repaired using one embodiment of the universal strike plate system (27), according to one embodiment. The universal strike plate system (27) partially fills the excess space (26) between the latch face (23) and the strike plate (14). The universal strike plate system (27) also bridges and covers the empty strike plate mortise (18) while serving as a mounting seat for the realigned strike plate (14). Depending upon the shape of the latch (24) and the degree of misalignment, the latch (24) may seat far enough into the universal strike plate system (27) to make it unnecessary to expand the latch hole mortise (19).

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

Accordingly, it is to be understood that the embodiments of the apparatus herein described are merely illustrative of the application of the principles of the apparatus. Reference herein to details of the illustrated embodiments is not intended to limit the scope of the claims, which themselves recite those features regarded as essential to the invention.

What is claimed is:

1. A universal strike plate system for use on a strike jamb, the universal strike plate system comprising:
a face plate comprising
a back surface configured for mounting the strike plate saddle onto the strike jamb;
a strike plate seat for mounting a strike plate to the strike plate seat, wherein strike plate seat is a recessed area of a front face surface of the face plat;
an elongated vertical side forming an open side of the strike plate seat configured to receive a latch or bolt mounted on a door, and
an elongated vertical side forming the closed side of the face plate that is configured to not receive the door latch;
wherein the strike plate seat defines a primary through hole to receive the latch or the bolt, wherein the primary through hole is vertically-centered in said recessed area; and
wherein the strike plate seat further defines at least two secondary through holes to receive fastening members so as to mount said strike plate saddle onto said strike jamb, wherein said secondary through holes are positioned in said face surface with at least one said secondary through hole positioned above said primary through hole and at least one said secondary through hole positioned below said primary through hole.

2. The universal strike plate system of claim 1, wherein the back surface comprises a protruding ridge for horizontally aligning the strike plate saddle against an outside corner of the strike jamb, wherein the protruding ridge is substantially perpendicular to the back surface, and wherein the protruding ridge extends vertically along said open side edge of the back surface.

3. The universal strike plate system of claim 1, wherein the open side comprises a midline mark for vertically aligning the strike plate saddle with the latch or the bolt, wherein the midline mark is vertically centered along the open side, and wherein the midline mark is comprised of an elevated, recessed, or colored mark.

4. The universal strike plate system of claim 1, wherein the back surface comprises a protruding ridge for horizontally aligning the strike plate saddle against an outside corner of the strike jamb, wherein the protruding ridge is perpendicular to the back surface, and wherein the protruding ridge extends vertically along the open side edge of the back surface; and
in which the open side comprises a midline mark for vertically aligning the strike plate saddle with the latch or the bolt, wherein the midline mark is vertically centered along the open side, and wherein the midline mark is comprised of an elevated, recessed, or colored mark.

5. A method of mounting a strike plate onto a strike jamb comprising:
providing a strike plate saddle to be mounted to the strike jamb, the a strike plate saddle comprising a face plate that defines a recessed area for receiving a strike plate, the recessed area defining a primary through hole that is configured to receive a door latch or door bolt and secondary through holes;
aligning the strike plate saddle on the strike jamb so that the latch or the lock bolt of a door aligns with a vertical center of the primary through hole in the strike plate saddle;
affixing the strike plate saddle onto the strike jamb with one or more fasteners through secondary through holes in the strike plate saddle;
aligning the strike plate on the face of the strike plate saddle;
pressing said strike plate against the recessed area of the strike plate saddle;
securing the strike plate to the strike plate saddle and the strike jamb with fasteners inserted through mounting holes in the strike plate that then pass through secondary holes in the strike plate saddle and into the strike jamb.

6. The method according to claim 5 wherein the strike plate saddle is separate from the strike jamb and the strike plate.

7. The method according to claim 5 further comprising pressing the strike plate saddle against the strike jamb so as to temporarily place the strike plate saddle to the strike jamb.

8. The method according to claim 5 further comprising creating or expanding mortise hole in said strike jamb to receive the latch or lock bolt if necessary.

9. The method according to claim 5 further comprising exposing a pre-applied adhesive substance on the back surface of the strike plate saddle.

10. The method according to claim 5 further comprising removing the strike plate.

11. The method according to claim 5 further comprising pressing said strike plate saddle against said strike jamb so as to temporarily mount said strike plate saddle to said strike jamb.

12. The method according to claim 5 further comprising exposing a pre-applied adhesive substance on the face of said strike plate saddle.

13. The method according to claim 5 wherein aligning the strike plate on the face of the strike plate saddle is performed so that the vertical center of said strike plate aligns with the vertical center of said primary through hole in said strike plate saddle.

14. A universal strike plate system for use on a strike jamb, the strike plate comprising:
a face plate comprising:
a back surface configured for mounting the strike plate saddle onto the strike jamb;
a strike plate seat for mounting a strike plate to the strike plate seat, wherein strike plate seat is recessed relative to a front face of the face plate as a recessed area of a front face surface;
an elongated vertical side forming an open side of the strike plate seat configured to receive a latch or bolt mounted on a door,
wherein the strike plate seat defines a primary through hole to receive the latch or the bolt; and
wherein the strike plate seat further defines at least two secondary through holes configured to receive fastening members so as to mount said strike plate saddle onto said strike jamb,
wherein the face plate is a component that is separate from the strike plate and also from the strike jamb.
